(19) United States
(12) Patent Application Publication
(10) Pub. No.: US 2012/0012078 A1
(43) Pub. Date: Jan. 19, 2012

(54) INTAKE MANIFOLD FOR INTERNAL COMBUSTION ENGINE

(76) Inventor: John Carl Lohr, Beverly Hills, MI (US)

(21) Appl. No.: 12/835,982

(22) Filed: Jul. 14, 2010

(51) Int. Cl. F02M 35/104

(52) U.S. Cl. 123/184.21

(57) ABSTRACT

An intake manifold for an internal combustion engine having a housing having a uniformly thick, outwardly facing arch shaped elongated arm for mounting to a cylinder head of the internal combustion engine with an outer surface of the arm having an outwardly facing projection disposed along a portion of a length of the elongated arm. The projection is integrally formed with the arm. The projection is at, or proximate to, the apex of the arch of the arch shaped arm.

### TECHNICAL FIELD

This disclosure relates generally to internal combustion engines and more particularly to intake manifolds used in such engines.

### BACKGROUND

As is known in the art, intake manifold for internal combustion engines have been constructed so that they are collapsible. One technique used to provide this collapsibility is to fabricate the intake manifold with a thinner region at various places of the manifold,

### SUMMARY

In one embodiment, an intake manifold for an internal combustion engine having a housing having a uniformly thick, outwardly facing arch shaped arm for mounting to a cylinder head of the internal combustion engine with an outer surface of the arm having an outwardly facing projection.

In one embodiment the arm is elongated and the projection is disposed along a portion of a length of the elongated arm.

In one embodiment, the projection is integrally formed with the arm.

In one embodiment, the projection is at, or proximate to, the apex of the arch of the arch shaped arm.

In one embodiment, a motor vehicle comprises: an internal combustions engine compartment disposed in a front end portion of the vehicle, such compartment having disposed therein: a radiator; and an internal combustion engine, disposed rearward of the radiator; having an intake manifold having an outer arch shaped housing, such housing having a plurality of projections integrally formed with the housing and projecting from the housing in a direction facing in the radiator.

In one embodiment, a motor vehicle comprises: an internal combustion engine compartment disposed in a front-end portion of the vehicle, such compartment having disposed therein: a radiator; and an internal combustion engine, disposed rearward of the radiator; having an intake manifold. The intake manifold comprises: a housing having a uniformly thick, outwardly facing arch shaped elongated arm for mounting to a cylinder head of the internal combustion engine. An outer surface of the arm has an outwardly facing projection disposed along a portion of a length of the arm.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a sketch of a motor vehicle having an internal combustion compartment disposed in a front-end portion of the vehicle and an engine mounted to an intake manifold in accordance with the disclosure;

FIG. 2 is a front view of the intake manifold used in the vehicle of FIG. 1 in accordance with the disclosure;

FIG. 3 is a side view of the intake manifold of FIG. 2 in accordance with the disclosure;

FIG. 4 is a cross sectional view of a portion of the intake manifold of FIG. 2, such cross section being taken along line 4-4 in FIG. 2; and

FIG. 5 is a side view of the engine and intake manifold in FIG. 1 and a radiator also disposed in the vehicle with the engine and intake manifold.

Like reference symbols in the various drawings indicate like elements.

### DETAILED DESCRIPTION

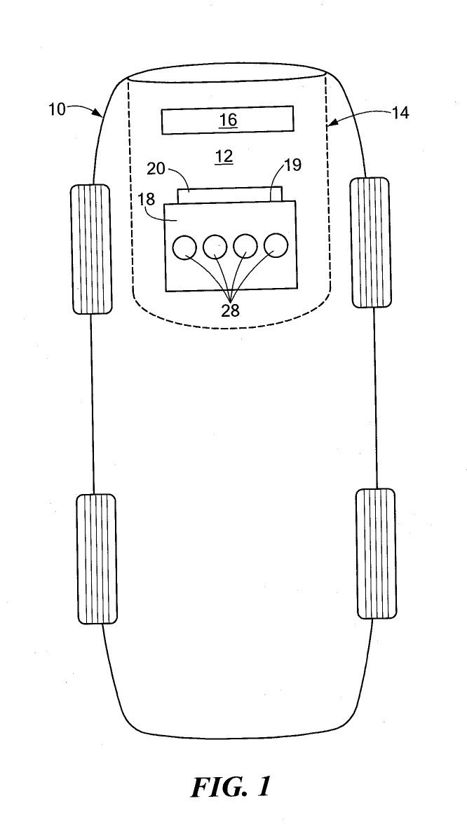

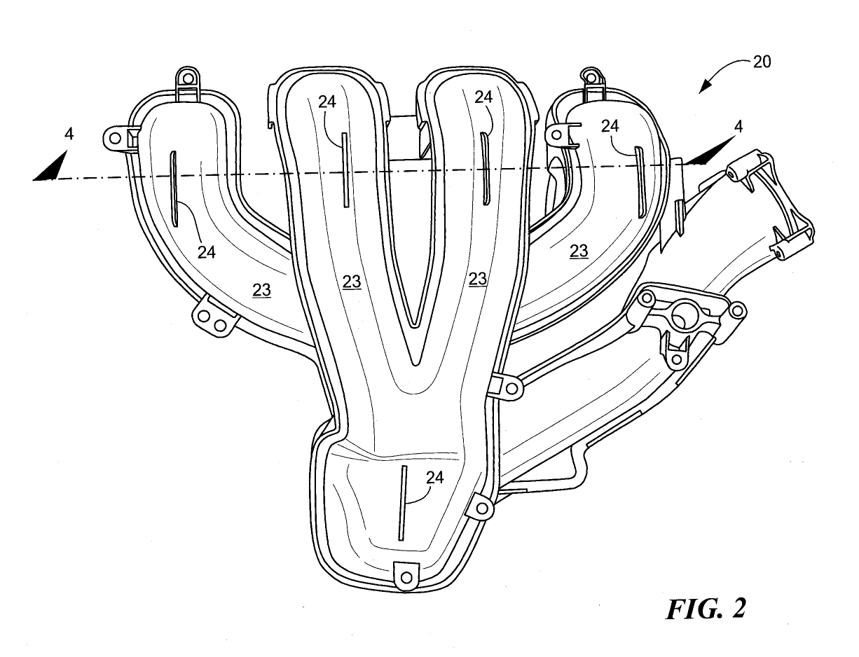

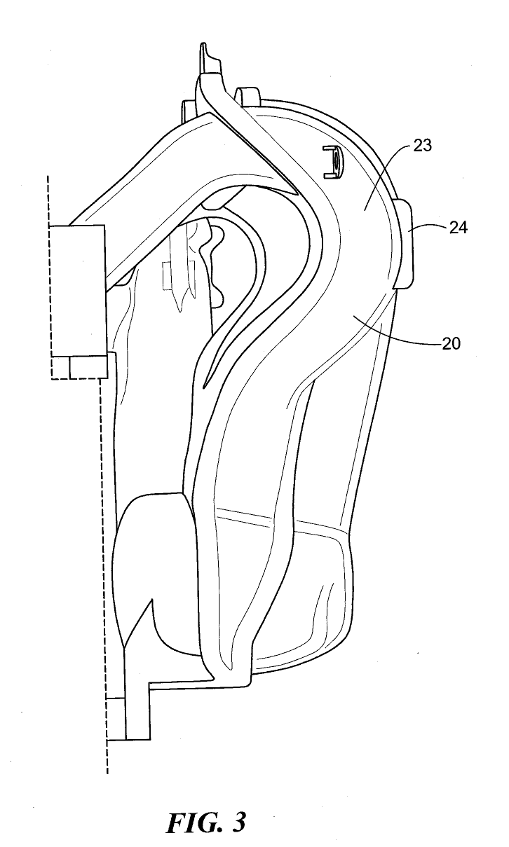

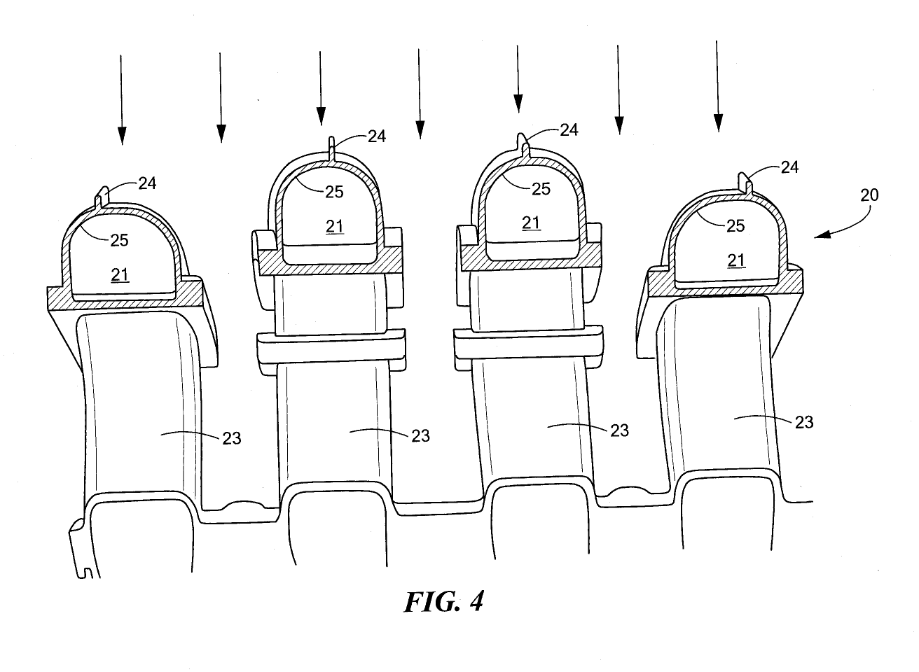

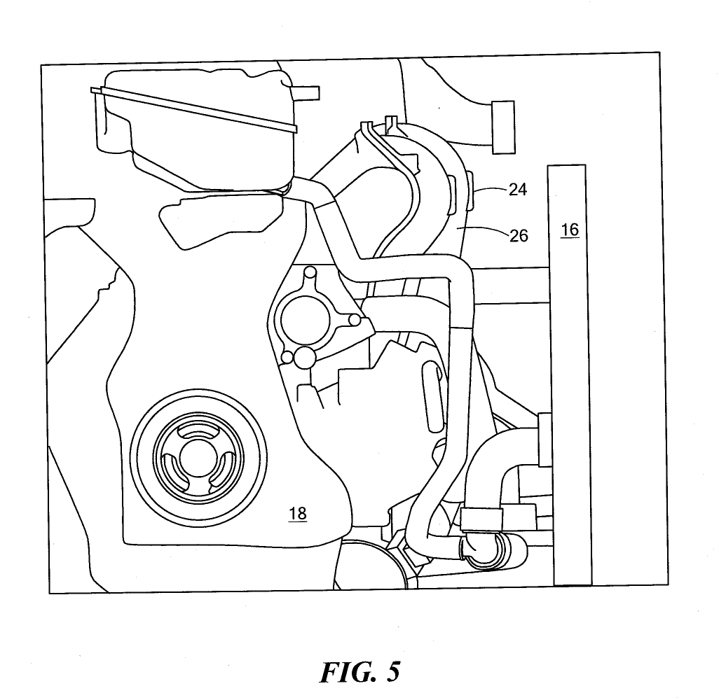

Referring now to FIG. 1, a motor vehicle 10 is shown having an internal combustion compartment 12 disposed in a front-end portion 14 of the vehicle 10. The compartment 12 has disposed therein: a radiator 16; and an internal combustion engine 18, disposed rearward of the radiator 16. The engine 18 has mounted to the cylinder wall 19 thereof, an intake manifold 20, shown more clearly in FIGS. 2, 3, 4 and 5. The intake manifold 20 is here a composite material, shown more clearly in FIG. 4. The housing has elongated, hollow arms 23 for carrying a mixture of fuel and air to the cylinders 28 (FIG. 1) of the engine 20. It is noted that the portion 21 has arch-shaped outer walls 25 (FIG. 5). These outer walls 25 have a uniform thickness. The arms 23 have a plurality of projections 24 integrally formed with the housing 22 and projecting from the housing 22 in a direction facing in the radiator, as shown in FIG. 5. More particularly, the projections 24 are at, or near, the apex of the arch of the arch-shaped outer walls 25 of arms 23. The projections 24 are disposed along a portion of a length of the elongated arms.

With such an arraignment, excessive forces on the projections 24 in a direction from the front of the vehicle towards the engine (the forces being indicated by the arrows in FIG. 4) will cause the manifold 20 to collapse.

A number of embodiments of the disclosure have been described. Nevertheless, it will be understood that various modifications may be made without departing from the spirit and scope of the disclosure. For example, more projection may be used. Further, the size and shape of the projects may be other than that shown in the FIGS. Accordingly, other embodiments are within the scope of the following claims.

What is claimed is:

1. An intake manifold for an internal combustion engine, comprising:
a housing having a uniformly thick, outwardly facing hollow arch shaped arm for mounting to a cylinder head of the internal combustion engine;
wherein an outer surface of the arm has an outwardly facing projection’

2. The intake manifold recited in claim 1 wherein the arm is elongated and wherein the projection is disposed along a portion of a length of the elongated arm.

3. The intake manifold recited in claim 1 wherein the projection is integrally formed with the arm.

4. The intake manifold recited in claim 1 wherein the projection is at, or proximate to, the apex of the arch of the arch shaped arm.

5. The intake manifold recited n claim 4 wherein the projection is integrally formed with the arm.

6. A motor vehicle, comprising:
an internal combustion engine compartment disposed in a front end portion of the vehicle, such compartment having disposed therein:
a radiator; and
an internal combustion engine, disposed rearward of the radiator; having an intake manifold having an outer arch shaped housing, such housing having a plurality of projections integrally formed with the housing and projecting from the housing in a direction facing in the radiator.

7. A motor vehicle, comprising:
an internal combustion engine compartment disposed in a front end portion of the vehicle, such compartment having disposed therein:
a radiator; and
an internal combustion engine, disposed rearward of the radiator; having an intake manifold, comprising:
a housing having a uniformly thick, outwardly facing arch shaped arm for mounting to a cylinder head of the internal combustion engine;
wherein an outer surface of the arm has an outwardly facing projection.

8. The motor vehicle recited in claim 7 wherein the arm is elongated and wherein the projection is disposed along a portion of a length of the elongated arm.

9. The motor vehicle recited n claim 7 wherein the projection is integrally formed with the arm.

10. The motor vehicle recited in claim 7 wherein the projection is at, or proximate to, the apex of the arch of the arch shaped arm.

11. The motor vehicle recited in claim 10 wherein the projection is integrally formed with the arm.
